(19) United States
(12) Patent Application Publication
(10) Pub. No.: US 2022/0061224 A1
(43) Pub. Date: Mar. 3, 2022

(54) GARDEN SHEARS

(71) Applicant: HO CHENG GARDEN TOOLS CO., LTD., Fu Shing Hsiang (TW)

(72) Inventor: Yao-Chung Huang, Fu Shing Hsiang (TW)

(21) Appl. No.: 17/010,498

(22) Filed: Sep. 2, 2020

(51) Int. Cl. A01G 3/02; A01G 3/047

(52) U.S. Cl. CPC A01G 3/021; A01G 3/0475

(57) ABSTRACT

A garden shears has a handle, a first cutting member, a handgrip, a second cutting member, an intermediate member and at least one driving member. The handle secures the first cutting member and is pivoted to the second cutting member by the second shaft hole, the handgrip secures the intermediate member, the third shaft hole is pivoted to the first shaft hole, the first end of the driving member is connected to the second connecting aperture of the intermediate member, the second end is connected to the first connecting aperture of the second cutting member, therefore, the first shaft hole, the second shaft hole, the first end and the second end form a four-bar linkage state. In addition, the evading groove of the handle is configured for accepting the second end, thereby the expanded swing range increases the maximum opening angle of the blade and the knife anvil.

### BACKGROUND OF INVENTION

### Field of Invention

The present invention relates to a garden shears, and more particularly to a garden shears with a better structure.

### Description of Related Art

The conventional garden shears are used for gardening work, such as trimming the branches, flowers and plants. When trimming thick branches, large gardening shears requiring both hands holding each handle at one end are used, the longer arms provide greater shearing force, and the larger opening of the cutting blade allows to cut thicker branches. In contrast, the general small garden shears is designed to be held by one hand, it has lighter weight so more convenient to use and carry and it is more suitable for long-term use. Therefore, the small garden shears held by one hand are generally preferred. However, the cutting opening range of conventional small garden shears is not easy to expand and is directly affected by the opening range of the two handles. When the opening range of the two handles is too large, it is impossible to hold and operate the gardening shears with one single hand, resulting in the loss of the original convenient features. Some one-handed gardening shears has enlarged cutting opening range, but requires a complicated mechanism, which results high overall cost increases the weight of the garden shears. Furthermore, the complicated structure is relatively prone to failure.

Therefore, it is desirable to provide a garden shears to mitigate and/or obviate the aforementioned problems.

### SUMMARY OF INVENTION

An objective of present invention is to provide a garden shears, which is capable of improving the above-mention problems.

In order to achieve the above mentioned objective, A garden shears has a handle, a first cutting member, a handgrip, a second cutting member, an intermediate member and at least one driving member. The handle secures the first cutting member and is pivoted to the second cutting member by the second shaft hole, the handgrip secures the intermediate member, the third shaft hole is pivoted to the first shaft hole, the first end of the driving member is connected to the second connecting aperture of the intermediate member, the second end is connected to the first connecting aperture of the second cutting member, therefore, the first shaft hole, the second shaft hole, the first end and the second end form a four-bar linkage state. In addition, the evading groove of the handle is configured for accepting the second end, thereby the expanded swing range increases the maximum opening angle of the blade and the knife anvil.

Other objects, advantages, and novel features of invention will become more apparent from the following detailed description when taken in conjunction with the accompanying drawings.

### BRIEF DESCRIPTION OF DRAWINGS

FIG. 1 is a three-dimensional view of a preferred embodiment according to the present invention.

FIG. 2 is a three-dimensional exploded view of the preferred embodiment according to the present invention.

FIG. 3 is a cross-sectional view of the preferred embodiment according to the present invention.

FIG. 4 is a front view of the preferred embodiment according to the present invention.

FIG. 5 is another cross-sectional view of the preferred embodiment according to the present invention.

FIG. 6 is another front view of the preferred embodiment according to the present invention.

FIG. 7 is another cross-sectional view of the preferred embodiment according to the present invention.

### DETAILED DESCRIPTION OF PREFERRED EMBODIMENT

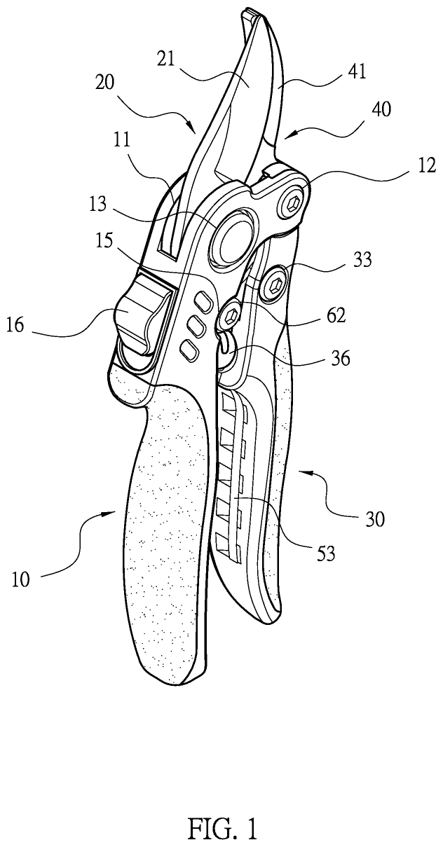

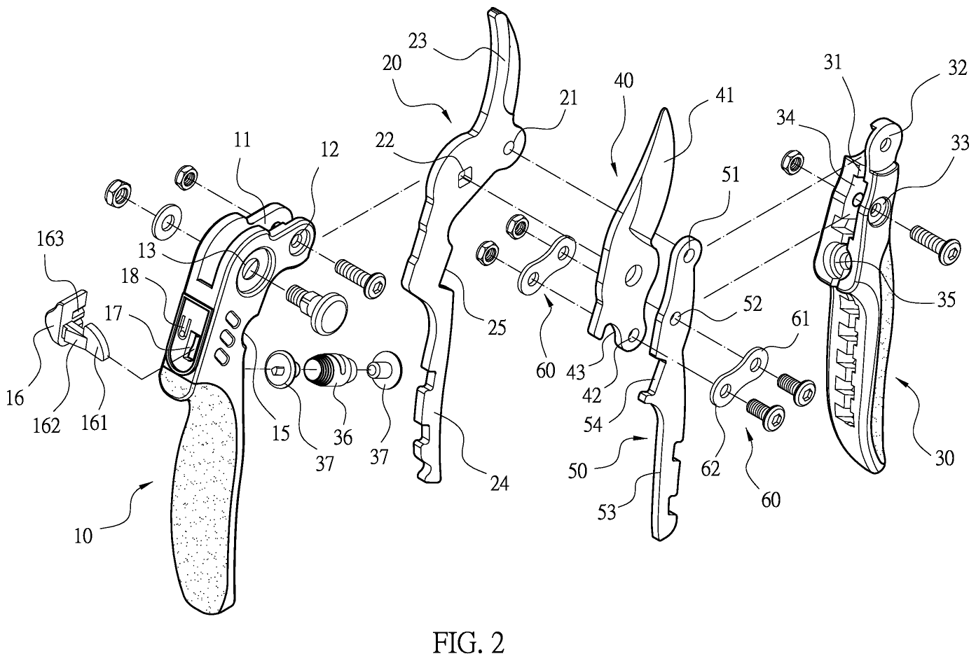

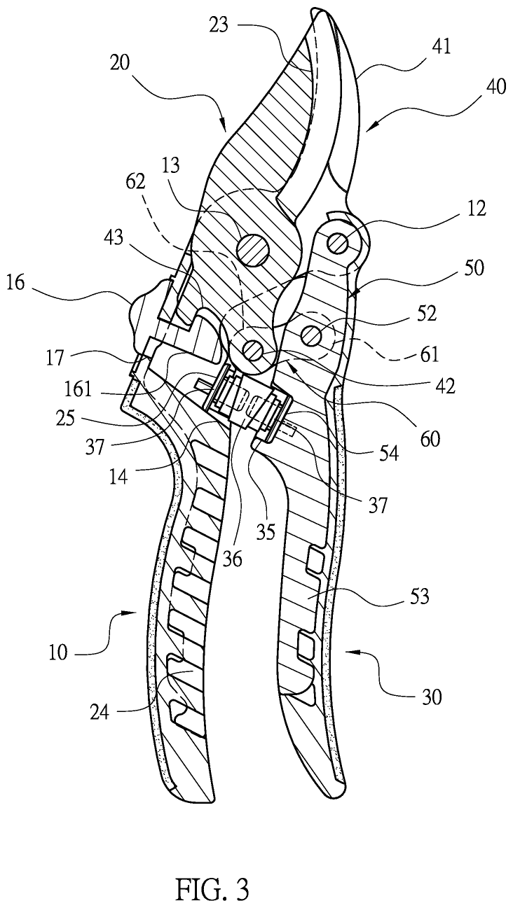

Please refer to FIG. 1, FIG. 2 and FIG. 3. A garden shears comprises a handle 10, a first cutting member 20, a handgrip 30, a second cutting member 40, an intermediate member 50 and at least one driving member 60. The handle 10 has an open slot 11 with a first shaft hole 12 and a second shaft hole 13 adjacent to each other, a jointing portion 14 is disposed on another side of the second shaft hole 13, and an evading groove 15 is disposed between the second shaft hole 13 and the jointing portion 14. The first cutting member 20 is disposed in the open slot 11, the first cutting member 20 has a through aperture 21 corresponding to the first shaft hole 12, a through hole 22 corresponding to the second shaft hole 13, and a knife anvil 23. The handgrip 30 has an assembly slot 31 at one end, a third shaft hole 32, and a fourth shaft 33 passing through the assembly slot 31, and the assembly slot 31 further has an accepting space 34 corresponding to the fourth shaft hole 33. The third shaft hole 32 of the handgrip 30 is disposed above the fourth shaft hole 33, a securing portion 35 is disposed on another side of the fourth shaft hole 33, and an elastic member 36 is disposed between the securing portion 35 and the jointing portion 14. The elastic member 36 is a scroll spring. The second cutting member 40 is pivoted onto the second shaft hole 13 of the handle 10, and the second cutting member 40 has a blade 41 corresponding to the knife anvil 23 at one end and a first connecting aperture 42 at another end. The intermediate member 50 is fixed on the assembly slot 31 of the handgrip 30 and has a shaft hole 51 aligned with the third shaft hole 32, and the third shaft hole 32 of the handgrip 30 and the shaft hole 51 of the intermediate member 50 are both pivoted at the first shaft hole 12 of the handle 10. The intermediate member further has a second connecting aperture 52 aligned with the fourth shaft hole 33. The at least one driving member 60 has a first end 61 pivoted onto the first connecting aperture 42 and a second end 62 pivoted onto the second connecting aperture 52, and the driving member 60 is rotatable in the accepting space 34. When the blade 41 and the knife anvil 23 are brought together, the evading groove 15 accepts the second end 62 of the driving member 60; when the blade 41 and the knife anvil 23 are separated, the driving member 60 increases the rotation range of the blade 41.

Furthermore, both ends of the elastic member 36 have a securing member 37 connecting to the jointing portion 14 and the securing portion 35. The first cutting member 20 has a lever 24 at an end opposite to the knife anvil 23 engaging with the handle 10, and the intermediate member 50 has a hilt 53 at an end opposite the shaft hole 51 engaging with the handgrip 30. The first cutting member 20 further has a pressing portion 25 between the through hole 22 and the lever 24, the intermediate member 50 further has an abutting portion 54 between the second connecting aperture 52 and the hilt 53, and the securing members 37 of the elastic member 36 respectively make contact with the pressing portion 25 and the abutting portion 54. In addition, the first cutting member 20 and the intermediate member 50 are both made of metal materials, the pressing portion 25 and the abutting portion 54 have higher pressure strength.

Moreover, the handle 10 is provide with a knob 16 having a hook 161 extending into the open slot 11, and the second cutting member 40 further has a cavity 43 configured for accepting the hook 161 of the knob 16. When the hook 161 of the knob 16 is pushed into the cavity 43, the knife anvil 23 and the blade 41 are locked together. The handle 10 has an elongated hole 17, the hook 161 further has a barb 162, and the hook 161 of the knob 16 is inserted in the elongated hole 17 and the barb 162 positions the knob 16 in the elongated hole 17. An elastic rib 18 is disposed on one side of the elongated hole 17 of the handle 10, the knob 16 further has a plurality of positioning slots 163, and the knob 16 is positioned by slipping the elastic rib 18 into the positioning slot 163.

For the structure assembly, please refer to FIG. 2 and FIG. 3. The first cutting member 20 engages with the handle 10 with the lever 24, the first cutting member 20 is inserted through the open slot 11, and the knife anvil 23 extends outward. Also, the through aperture 21 is aligned with the first shaft hole 12, the through hole 22 is aligned with the second shaft hole 13, the first end 61 of the driving member 60 is pivoted onto the second connecting aperture 52 of the intermediate member 50, and the second end 62 of the driving member 60 is pivoted onto the first connecting aperture 42 of the second cutting member 40. Furthermore, the hilt 53 of the intermediate member 50 engages with the handgrip 30 so that the shaft hole 51 is aligned with the third shaft hole 32, and the second connecting aperture 52 is aligned with the fourth shaft hole 33. Furthermore, the second cutting member 40 is pivoted to the second shaft hole 13 of the handle 10, the shaft hole 51 and the third shaft hole 32 are pivoted to both of the through aperture 21 and the first shaft hole 12 at the same time, and finally the securing members 37 at both ends of the elastic member 36 are respectively secured to the jointing portion 14 and the securing portion 35, so that the elastic member 36 is securely sandwiched between the handle 10 and the handgrip 30 to complete the assembly of structure.

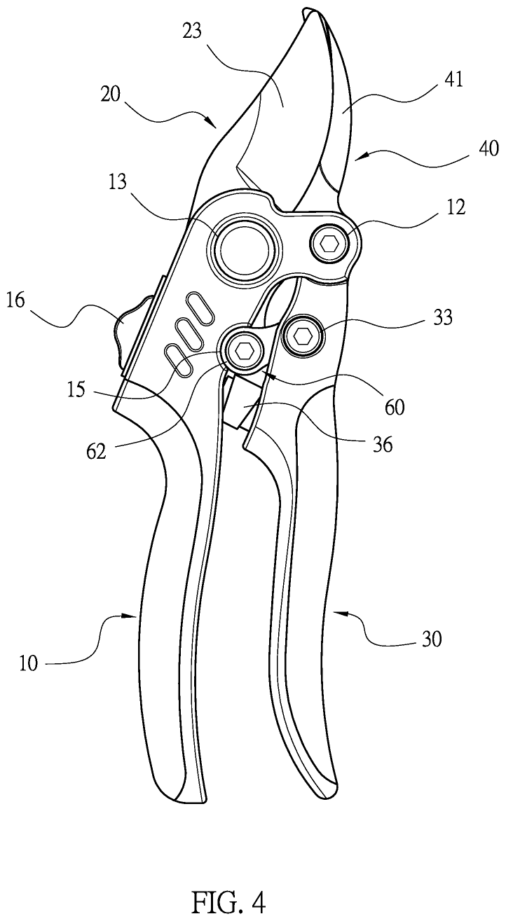

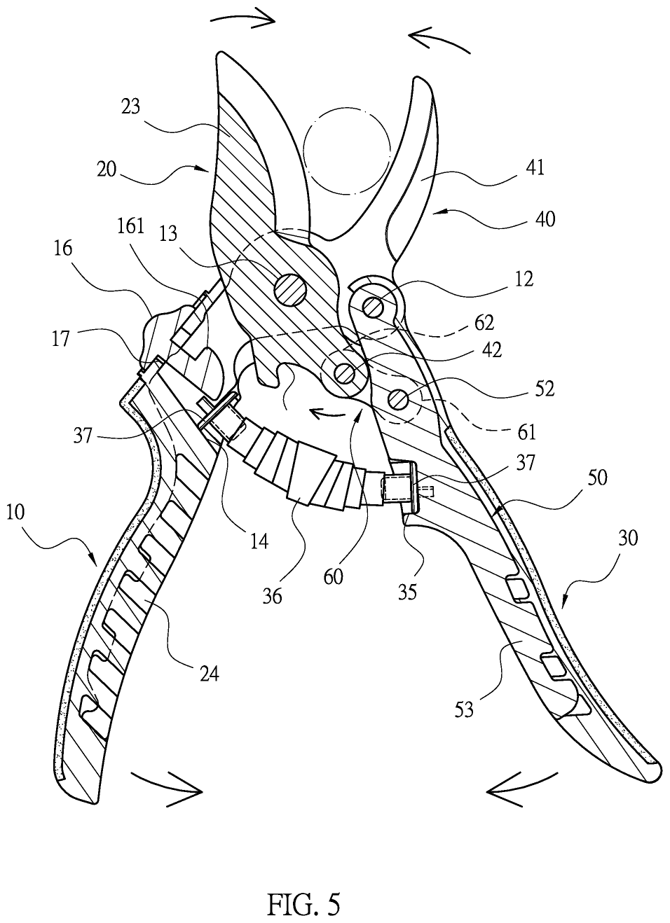

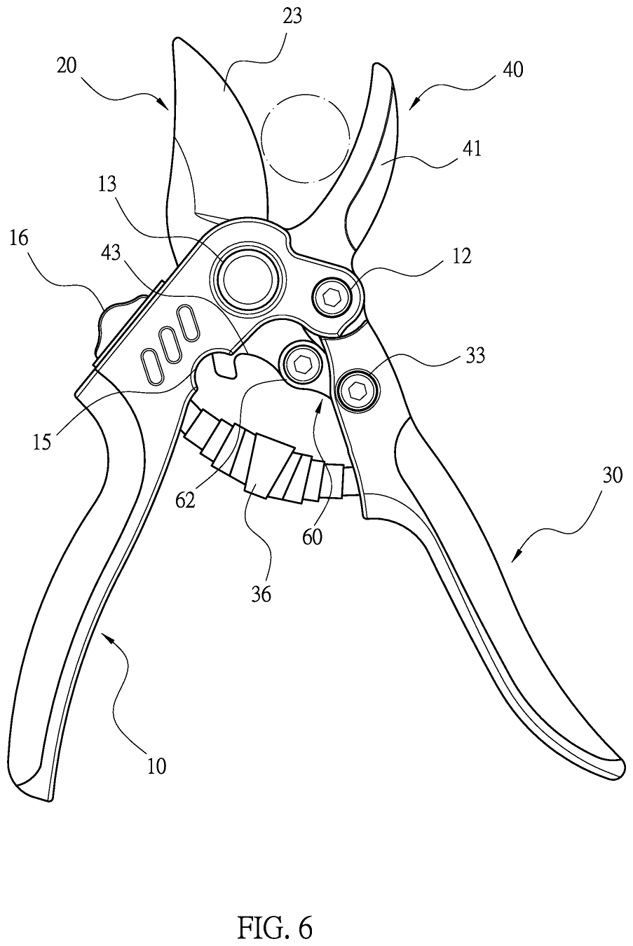

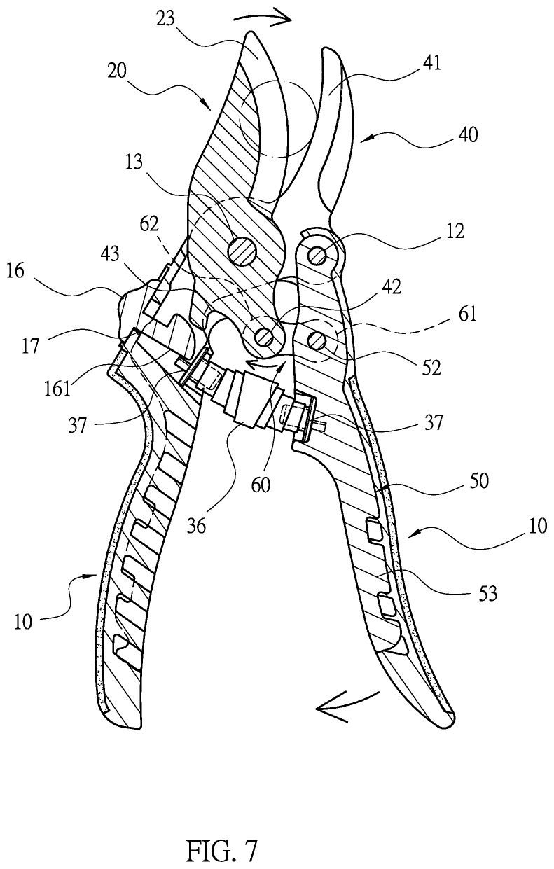

For the actual operation, please refer to FIG. 2 to FIG. 7. When the blade 41 and the knife anvil 23 are closed together, the handle 10 and the handgrip 30 are also closed to each other, and the second cutting member 40 and the driving member 60 are clasped together due to rotation of the second end 62. Since the handle 10 and the handgrip 30 compress the elastic member 36, and at the same time the evading groove 15 of the handle 10 accepts the second end 62, the swing range of the driving member 60 is increased. When the blade 41 and the knife anvil 23 are separated from each other, the elastic force of the elastic member 36 pushes out the handle 10 and the handgrip 30, which allows the handle 10 and the handgrip 30 to oscillate around the first shaft hole 12 and the third shaft hole 32 as a common axis. Also, the second cutting member 40 uses the second shaft hole 13 as an axis to rotate and is pulled by the driving member 60 to be apart from the knife anvil 23. Therefore, the blade 41 and the knife anvil 23 are open to the maximum opening angle. On the contrary, by holding the handle 10 and the handgrip 30 together, the blade 41 and the knife anvil 23 have a shearing effect.

With the above structure of the embodiment, the following benefits can be obtained: the handle 10 secures the first cutting member 20 and is pivoted to the second cutting member 40 by the second shaft hole 13, the handgrip 30 secures the intermediate member 50, the third shaft hole 32 is pivoted to the first shaft hole 12, the first end 61 of the driving member 60 is connected to the second connecting aperture 52 of the intermediate member 50, the second end 62 is connected to the first connecting aperture 42 of the second cutting member 40, therefore, the first shaft hole 12, the second shaft hole 13, the first end 61 and the second end 62 form a four-bar linkage state. In addition, the evading groove 15 of the handle 10 is configured for accepting the second end 62, thereby increasing the swing range of the driving member 60, and the expanded swing range increases the maximum opening angle of the blade 41 and the knife anvil 23, which effectively increases the applicable pruning range.

Although the present invention has been explained in relation to its preferred embodiment, it is to be understood that many other possible modifications and variations can be made without departing from the spirit and scope of invention as hereinafter claimed.

What is claimed is:

1. A garden shears comprising:
a handle having an open slot with a first shaft hole and a second shaft hole adjacent to each other, a jointing portion disposed on another side of the second shaft hole, and an evading groove disposed between the second shaft hole and the jointing portion;
a first cutting member disposed in the open slot, the first cutting member having a through aperture corresponding to the first shaft hole, a through hole corresponding to the second shaft hole, the first cutting member further having a knife anvil;
a handgrip having an assembly slot at one end, a third shaft hole, and a fourth shaft passing through the assembly slot, the third shaft hole of the handgrip disposed above the fourth shaft hole, a securing portion disposed on another side of the fourth shaft hole, and an elastic member between the securing portion and the jointing portion;
a second cutting member pivoted onto the second shaft hole of the handle, the second cutting member having a blade corresponding to the knife anvil at one end and a first connecting aperture at another end;
an intermediate member fixed on the assembly slot of the handgrip and having a shaft hole aligned with the third shaft hole, the third shaft hole of the handgrip and the shaft hole of the intermediate member both pivoted at the first shaft hole of the handle, and the intermediate member further having a second connecting aperture aligned with the fourth shaft hole; and
at least one driving member having a first end pivoted onto the first connecting aperture and a second end pivoted onto the second connecting aperture.

2. The garden shears as claimed in claim 1, wherein the handle is provide with a knob having a hook extending into the open slot, and the second cutting member further has a cavity configured for accepting the hook of the knob.

3. The garden shears as claimed in claim 2, wherein the handle has an elongated hole, the hook further has a barb, and the hook of the knob is inserted in the elongated hole and the barb positions the knob in the elongated hole.

4. The garden shears as claimed in claim 3, wherein an elastic rib is disposed on one side of the elongated hole of the handle, the knob further has a plurality of positioning slots, and the knob is positioned by slipping the elastic rib into the positioning slot.

5. The garden shears as claimed in claim 1, wherein the elastic member is a scroll spring, both ends of the elastic member have a securing member connecting to the jointing portion and the securing portion.

6. The garden shears as claimed in claim 5, wherein the first cutting member has a lever at an end opposite to the knife anvil engaging with the handle, and the intermediate member has a hilt at an end opposite the shaft hole engaging with the handgrip.

7. The garden shears as claimed in claim 6, wherein the first cutting member further has a pressing portion between the through hole and the lever, the intermediate member further has an abutting portion between the connecting aperture and the hilt, and the securing members of the elastic member respectively make contact with the pressing portion and the abutting portion.

8. The garden shears as claimed in claim 1, wherein the assembly slot further has an accepting space corresponding to the fourth shaft hole, and the driving member is rotatable in the accepting space.
